(19) United States
(12) Patent Application Publication
(10) Pub. No.: US 2008/0215504 A1
(43) Pub. Date: Sep. 4, 2008

(54) Revenue Allocation in a Network Environment

(76) Inventors: Daniel Aaron Issen, San Francisco, CA (US); Matthew William Mengerink, San Jose, CA (US)

Correspondence Address: NORTH WEBER & BAUGH LLP, 2479 E. BAYSHORE ROAD, SUITE 707, PALO ALTO, CA, 94303, US

(21) Appl. No.: 11/681,635

(22) Filed: Mar. 2, 2007

(51) Int. Cl. G06F 17/00; G06F 17/30

(52) U.S. Cl. 705/400; 707/3; 707/E17.014

(57) ABSTRACT

The present invention relates to a search engine for providing a search result responsive to a search query received from a user and for allocating revenue generated from one or more advertisements included with the search result to the authors of the content that makes up the search result.

### BACKGROUND

A. Technical Field

The present invention relates generally to Internet technologies, and more particularly, to allocating revenue received from advertisements.

B. Background of the Invention

As the amount of information available over the Internet continues to increase, users are relying more heavily on search engines to locate the information for which they are interested. As a result, search engines have become some of the most popular web sites on the Internet. Search engine companies have capitalized on this popularity by including advertisements with their search results. Often, the search engine can determine what information the user is interested in based on the keywords of the user's search. In response, the search engines are capable of matching advertisements displayed to a user with the search query entered by the user.

Advertisers are willing to pay a premium to search engines for targeted advertisements. As a result, search engine providers have become some of the most profitable businesses on the Internet. However, the individuals who create and maintain the content of interest to the users do not share in the revenue generated as a result of the display of the advertisements with the search queries.

Another problem with current search engines is that the search results returned for a given keyword search often contain web pages that are not relevant to the user's query. The search results may comprise links to web pages that are completely irrelevant to the user's search query, may be out of context with respect to the user's search query, may be duplicates of other web pages in the search results, may contain low quality content, or may leave out important and relevant pages. These problems often arise due to the automated nature of search engines. Typically, individual web pages that are searchable by the search engine are indexed by a web crawler or other automated software routine which scours the Internet to locate and index various web pages distributed throughout the Internet. These crawler programs typically look at the metadata associated with the web page and the actual text of the web page to determine how to index the web page.

Traditional search engines typically return pages based on an algorithm that determines which pages have the strongest keyword match to the user's search terms, and which pages are most often linked to by other web pages. Due to the vast number of pages and the simplistic method of selecting and ranking pages in search results, search engine users often have literally thousands or tens of thousands of pages returned in search results. These search results are full of duplicate content, irrelevant content, low quality content, and old content. Important and relevant content may be missing. And, there is no coherent organization or structure for the content.

As a result, a user may spend significant time reviewing web pages which are irrelevant or useless with respect to the user's search query, as well as searching multiple times to try to find all the information they need.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1A is network environment 170 according to one embodiment of the invention.

FIG. 1B is a block diagram 100 of a search engine according to one embodiment of the invention.

FIG. 2 is an interface 200 for creating a container according to one embodiment of the invention.

FIG. 3 is a search result 310 according to one embodiment of the invention.

FIG. 4 is a flow chart of a method 400 for allocating revenue according to one embodiment of the invention.

### DETAILED DESCRIPTION OF THE PREFERRED EMBODIMENTS

Systems and apparatuses for a cooperative search engine and methods for sharing revenue between a search engine provider and the authors of containers are described. For purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, including software, hardware, or firmware, or a combination thereof. Accordingly, the figures described below are illustrative of specific embodiments of the invention and are meant to avoid obscuring the invention.

Reference in the specification to “one embodiment,” “a preferred embodiment” or “an embodiment” means that a particular feature, structure, characteristic, or function described in connection with the embodiment is included in at least one embodiment of the invention and may also be in more than one embodiment. The appearances of the phrase “in one embodiment” or “in an embodiment” in various places in the specification are not necessarily all referring to the same embodiment.

I. Overview

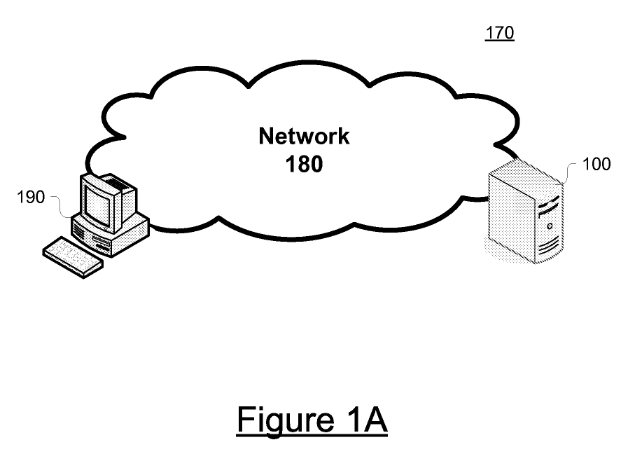

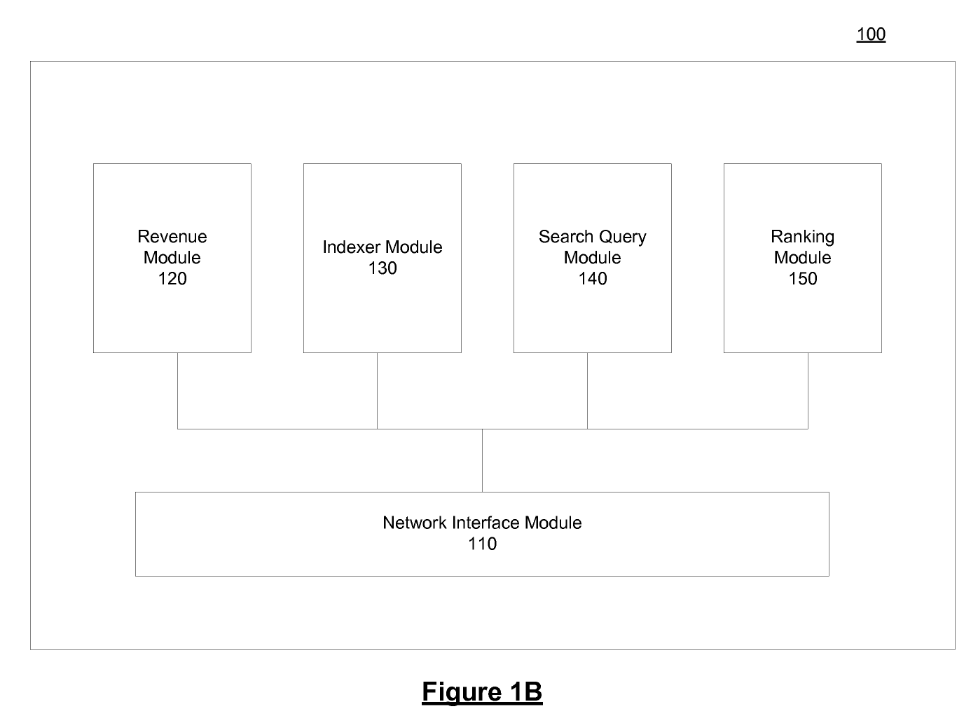

The present invention relates to a cooperative search engine for providing a search result responsive to a search query received from a user and for allocating revenue generated from advertisements or other revenue generating services provided with the search result to the authors of the containers that make up the search result. FIG. 1A illustrates a network environment 170 according to one embodiment of the invention. Network environment 170 comprises a user computer 190 and a search engine 100 connected to a network 180. User computer 190 and search engine 100 may communicate with each other over network 180 using network technologies that are well known in the art. It should be noted that search engine 100 in FIG. 1A is illustrated as a single server for example purposes only. One skilled in the art will recognize that search engine 100 may comprise multiple servers connected over a public or one or more private networks.

FIG. 1B is a block diagram of a search engine 100 according to one embodiment of the present invention. Search engine 100 comprises a network interface module 110, a revenue module 120, an indexer module 130, a search query module 140, and a ranking module 150. As illustrated in FIG. 1B, network interface module 110, revenue module 120, indexer module 130, search query module 140 and ranking module 150 may be communicably coupled together. In alternative embodiments, each module may be communicably coupled to the one or more other modules with which it sends or receives information. One skilled in the art will recognize that the modules may be implemented in hardware, software, firmware or a combination thereof. Further, one skilled in the art will recognize that one or more modules may be implemented on a single computer or server. One skilled in the art will also recognize that one or more modules may be implemented on a separate computer or server.

Network interface 110 provides an interface between the search engine 100 and a network 180, such as the Internet. The search engine receives information from users over the network 180 and transmits information to users over the network 180 through network interface 110. Examples of information that may be transmitted between search engine 100 and user computer 190 over the network 180 include search queries, search results and container information as will be discussed further herein.

II. Container Creation

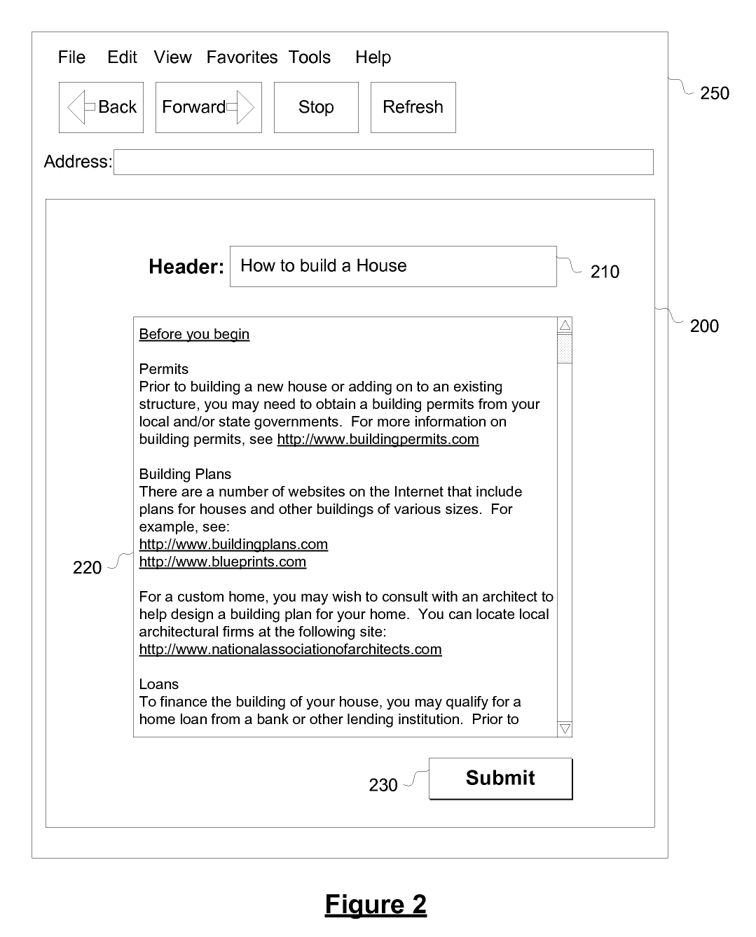

In one embodiment, the search engine provides an interface through which users may create a container that includes content relevant to a particular topic. For example, the interface may be a web page that the user accesses over a network and through which the user may input information about a topic, including but not limited to, text, links to other sources of information, graphics, multimedia files and other data. FIG. 2 illustrates an example container interface 200 according to one embodiment of the invention. Interface 200 comprises two text boxes 210 and 220 through which a user may input the information that makes up the container and a submit button 230. In one embodiment, an author inputs the topic of the container in header text box 210. In one embodiment, the header may be analogous to a title or question that identifies the topic of the container.

In one embodiment, the body of the container is created by inputting information into text box 220. The author may input text about the topic and/or include links to other sources of information, such as web pages or other data, relevant to the topic identified in the header. In an embodiment, advertisements, affiliate program links, and/or other revenue generating services may also be included in the container to generate revenue as will be discussed further herein. When the author is satisfied with the container contents, the author may submit the container to the search engine by selecting (e.g. clicking) submit button 230.

FIG. 2 illustrates an example container that includes information on how to build a house. As illustrated, the author has input “How to build a house” into header text box 210. This header identifies the topic of the container and may be used by the search engine to properly index the container within a database or other storage medium. In the body of the container (text box 220), the author has input information related to the topic identified in the header. In this example, the author has input text and links to other web sites that provide information to the user about building a house. In this sense, a container is like a search result hand-crafted and saved by the author based on a significant amount of time spent searching for information and with editorial value added by filtering out irrelevant, duplicate and low value content. Users often search for the same information again and again on the Internet. Containers provide a way for an author to save useful results they have found for a search so that when others search on the same topic, those users will find a relevant, comprehensive, concise, high-quality, and coherent search result ready and waiting.

In one embodiment, when the author selects (e.g. clicks) submit button 230, the container information input into interface 200 is transmitted from the user's computer 190 to search engine 100 over network 180. Search engine 100 receives the container and stores the container in a storage medium. In one embodiment, the storage medium is a database, however, one skilled in the art will recognize that storage medium may be any volatile or non-volatile storage device, including but not limited to, disk storage and flash memory. In an alternative embodiment, the containers may be stored external to search engine 100 and may be indexed by search engine 100 from the external storage location.

In one embodiment, the search engine associates each container with the author of the container. For example, the search engine may require each user to register with the search engine before allowing the user to create a container through interface 200. The search engine may create a user account for each registered user and associate the user with containers stored in the storage medium that have been authored by the user. Alternatively, the search engine may allow a user to identify one or more containers stored external to the search engine and indexed by the search engine which the user authored. For example, the search engine may include a field in the database or storage medium that identifies the author (or owner) of a given container.

When a registered user logs into the search engine website, the user may create new containers or view containers previously authored by the user and stored in the storage medium. The user may edit a previously-created container using the same or a similar interface used to create a container. For example, the header of a previously created container may be displayed in text box 210 and the body may be displayed in text box 220, as illustrated in FIG. 2. The user may edit the text within the text boxes 210 and 220 and update the container by selecting submit button 230.

In one embodiment, indexer 130 creates an index of the words found within the containers to facilitate searching of the containers. For example, the indexer may comprise software that parses each container and creates an index of the keywords used in the header and/or body of the container. The indexer 130 may remove commonly used words, such as “a,” “an,” and “the,” from the container and store the remaining words and the frequency of their occurrence within the index. Additionally, the indexer may normalize words within the index by converting each word to its simplest form (e.g. converting “building” to “build”) and making all the letters lower case. This assists in the indexing of the keywords of the container and also reduces the number of words/phrases within the index that need to be compared during a search. In one embodiment, the container may be indexed using the header information. One skilled in the art will recognize that there are a number of methods that may be used to index documents within a search engine that are well known in the art. All such methods are considered within the scope of the present invention.

III. Searching Containers

In one embodiment, users may search the containers by submitting a search query to search engine 100 over a network, such as the Internet. For example, the search engine may provide a search interface through which users may enter a search query that is transmitted to search engine 100. The search query may include one or more keywords or a question that identifies a topic or subject in which the user is interested.

Upon receiving the search query, the search engine may compare the search query with the information of the containers stored by the search engine to identify one or more containers relevant to the search query. In one embodiment, each search query is passed to the search query module 140, which identifies containers that are relevant to the search query. For example, the search query module 140 may comprise software, hardware, firmware or a combination thereof for comparing the words and/or phrases of the search query with the index created by the indexer to identify those containers that include words and/or phrases that match the words and/or phrases of the search query.

In one embodiment, search query module 140 also creates a search result that is transmitted to the user over network 180. As discussed further herein, the search result may be a web page that includes links to containers relevant to the search query along with one or more advertisements. The search query module 140 may also determine which containers are most relevant to the search query and order the links within the search result accordingly. One skilled in the art will recognize that there are a number of ways to determine relevance. For example, relevance may be determined based simply on the frequency in which the words and/or phrases of the search query match words and/or phrases within a particular container.

In another embodiment, the relevance of a container to a search query may be based on a ranking criteria determined by the ranking module 150. For example, ranking module 150 may comprise software, hardware, firmware or a combination thereof that ranks containers according to various criteria. As discussed further herein, the ranking for a container may be based on the number of times the container is accessed by users, feedback from users about the container and/or the number of links within the container selected by users. One skilled in the art will recognize that there are a number of ways to rank the containers stored within the search engine 100, all of which are considered within the scope of the present invention.

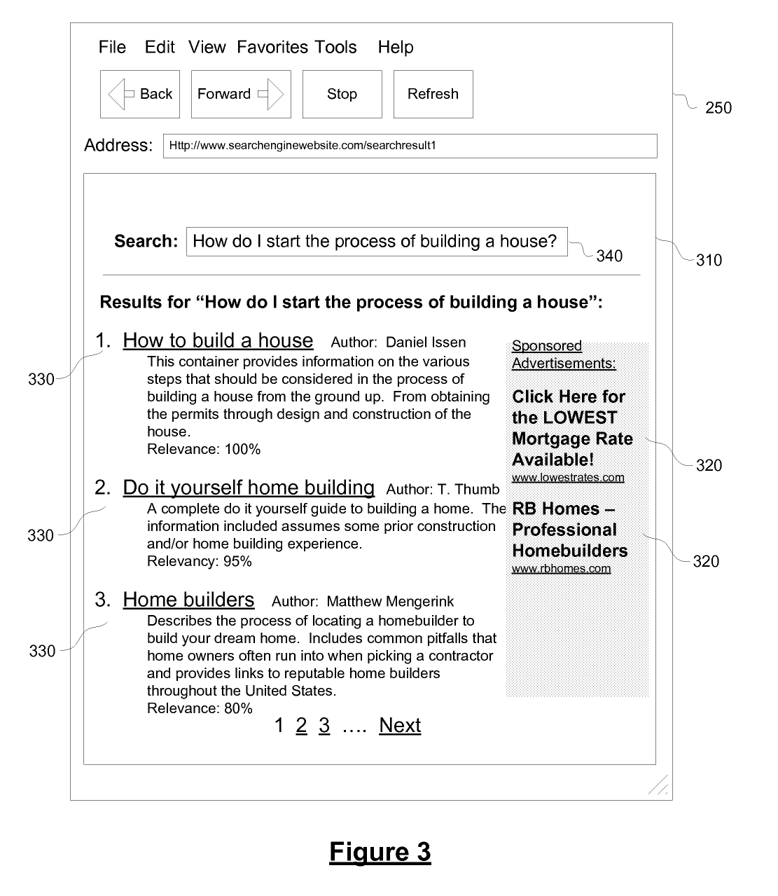

FIG. 3 illustrates an example search result 310 according to one embodiment of the invention. In this example, the search result 310 is displayed to a user through a browser window 250. As illustrated, search result 310 includes three links 330 to containers relevant to the user's search query 340. In this example, the header of the container is the text of the link to the container and each link is accompanied by a brief description of the container and identifies the author of the container.

In this embodiment, search result 310 also comprises two advertisements 320 displayed to the user with the links 330 to the relevant containers. In one embodiment, the search engine receives revenue associated with the display of the advertisements. For example, some advertisers pay for the display of their advertisements on a pay per impression basis. Each time the advertisement is displayed to a user, the advertiser pays an amount to the owner of the web page displaying the advertisement. As another example, some advertisers pay on a click-through or pay per click basis. When a user clicks on an advertisement displayed to the user, an amount is paid to the operator of the web page displaying the advertisement (in this example, the search engine provider). One skilled in the art will recognize that there are other ways (besides advertisements) for a search engine provider to generate revenue associated with the display of search results to a user. All such methods are considered within the scope of the present invention.

The example search result 310 illustrated in FIG. 3 displays three links 330 to relevant containers. In this example, additional relevant containers may be accessed by the user by clicking on the numbered links at the bottom of search result 310. For example, if the user does not find the information for which they are searching in the first three containers, the user may request the second page of the search result by clicking on the “2” link. Clicking on this link transmits a request for a second web page of the search result. The second web page may comprise additional links to containers relevant to the search criteria. One skilled in the art will recognize that the number of links 330 presented to the user in the search result may vary. In one embodiment, the search result includes links to all containers relevant to the search query.

IV. Ranking

In one embodiment, the links to the containers within the search results may be ordered according to a ranking criterion, or criteria. For example, the ranking order of the links may be based on feedback received from one or more users. When a user performs a search by entering a search query, the search result displayed to the user may include a feedback form that can be used by the user to provide their opinion on the relevance (e.g. utility) of the container to their search query. The feedback form may be as simple as a thumbs up/down icon that is associated and displayed with each link in the search results. The user may select either the thumbs up or thumbs down icon depending on the user's opinion of the relevance of the container to the search query. Alternatively, the feedback form may allow the user to specify with greater specificity, the utility of the container to the search query, such as a ranking on a scale of 1 to 5, etc.

One skilled in the art will recognize that there are a number of techniques that are well known in the art for ranking the utility or other attributes of containers and that the present invention is not limited to rankings based on feedback forms presented to the users. Other ranking methods, including but not limited to, ranking a container based on the time spent reviewing a container, and/or the number of links within a container that are selected by users (e.g. click-throughs) are also considered within the scope of the present invention.

One problem with many ranking systems is that they may be influenced by software programs or agents that are commonly referred to as bots. These software programs interact with network services as if they are a person and may be used to artificially inflate or deflate the ranking of a container. For example, individuals or companies may use bots to artificially inflate the feedback associated with their containers to improve the ranking and direct more traffic and revenue to their containers. Alternatively, bots may be used to negatively influence the feedback associated with containers authored by others, thus improving the ranking of their container within the search engine 100.

In one embodiment, associative ranking may be used to improve the rankings and help prevent software programs or agents from artificially increasing or decreasing the ranking of a container. Due to the cooperative nature of a search engine according to one embodiment of the present invention, individuals provide the content and influence the ranking of containers within the search engine. For example, when user feedback is used as a factor in ranking containers, the feedback influences the ranking of a container within the search engine.

In one embodiment, a user's feedback with respect to one or more containers may be compared with the feedback provided by other users for the same containers. Based on this comparison, a container's ranking may be customized based on feedback from users who have demonstrated similar opinions about other containers within search engine 100. One aspect of this embodiment of the invention is that the ranking of a container may vary depending on the user who is accessing the container. As a result, the container's position within a search result for a given search query may vary depending on the user who input the query.

This embodiment limits the influence of software agents because the software agents will likely provide negative feedback for multiple containers and/or positive feedback for a single container. Since it is unlikely that a user will provide a similar pattern of feedback, it is unlikely that the comparison of the user's feedback will match the feedback provided by a software bot. As a result, the ranking of a container for a given user is unlikely to be influenced by a software bot.

Ranking containers based on the relevance of each container to a search query provides an incentive to container authors to focus the subject of a container to a particular topic. If the author addresses multiple topics within a container, the author runs the risk of receiving poor feedback from users who feel that the container included information that was not relevant to their query. Similarly, if the author chooses a header that does not match the contents of the container, users will provide poor feedback for the container. Poor feedback will affect the containers position within the search results. As will be discussed further herein, this will likely decrease the amount of traffic and/or the amount of revenue the container will receive.

The ratings also provide incentive to the authors of the containers to continually improve and update the information included in the container. If the information in the container becomes outdated or if the author does not add new information to the container, the authors runs the risk that other authors will create containers covering the same topic. If these containers include additional or updated information, they will likely be considered more relevant and will receive better feedback and more traffic than outdated or stale containers.

V. Revenue Sharing

As discussed previously, search engine 100 may receive revenue associated with the display of advertisements or other revenue generating services included with the search results. In one embodiment, revenue module 120 may comprise software, hardware, firmware or a combination thereof that audits the revenue received from the display of advertisements. For example, revenue module 120 may track the revenue received from the display of various advertisements and the search query that produced the search result that included the advertisement. This information may be used by the search engine provider to improve the placement of advertisements and provide information to advertisers about the performance of their advertisements.

In one embodiment, the search engine provider shares advertising revenue with the owners of the containers that were included in the search result that generated the revenue. In this embodiment, revenue module 120 keeps track of the containers listed in a search result page that included an advertisement or other service which generated revenue. The revenue module 120 may identify the owner of each of the containers within the search result and allocate a portion of the revenue received from the advertisement with the owners of the containers that were part of the search result that included the advertisement. This provides an incentive for users to author containers.

It should be noted that the owner of a container is typically the author. However, authors may transfer the rights to revenue received from their containers to a third party. In such instances, the third party is the owner of the container and receives the portion of the advertising revenue allocated by the search engine provider.

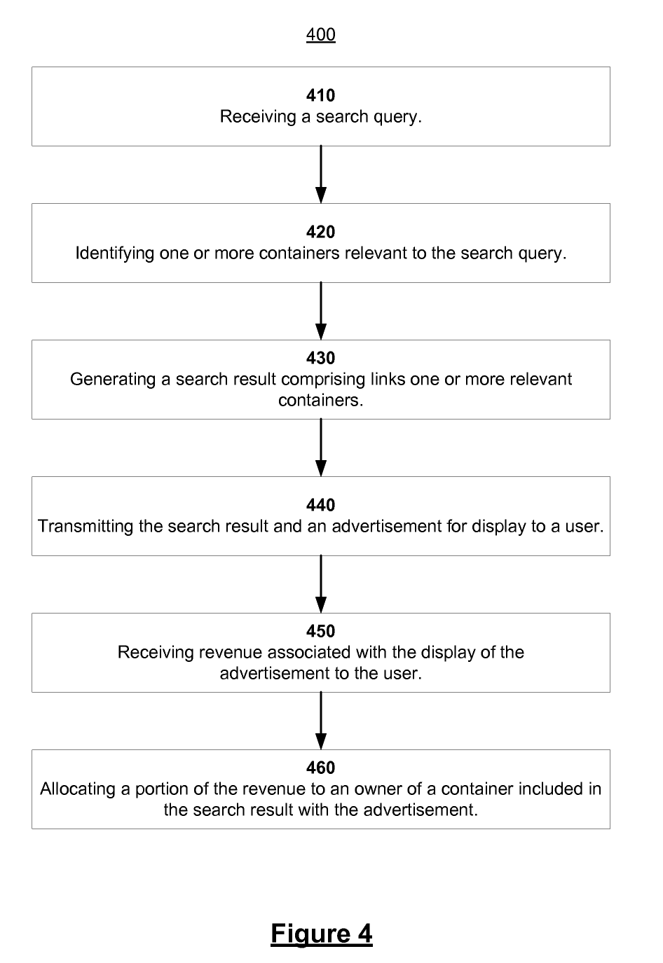

FIG. 4 is a flow chart of a method 400 for distributing revenue generated from the display of a search result according to one embodiment of the invention. In step 410, the search engine receives a search query from a user over a network such as the Internet. In step 420, the search engine identifies one or more containers that are relevant to the search query. As discussed previously, the search engine may compare the search query against an index and/or the header or body of containers to identify relevant containers. In one embodiment, the owner of one or more of the containers is known to the search engine.

In step 430, the search engine generates a search result that comprises links to one or more containers relevant to the search query. In one embodiment, the search result may be a single web page that provides a link to each of the relevant containers. In an alternative embodiment, the search result may spread the links to relevant containers over multiple web pages that may be successively accessed by a user. For example, the search engine may provide a first page of the search result that comprises links to a first set of relevant containers, such as illustrated in FIG. 3. If the user does not find the information for which they are searching in the first set of containers, the user may request the second page of the search result which comprises links to the next set of relevant containers. As discussed above, the links may be ordered within the search result according to a ranking criterion.

In step 440, the search engine transmits the search result and one or more advertisements for display to the user who submitted the search query. As discussed above, the search result may be a web page or other document that includes one or more relevant links which is transmitted to a user over a network 180, such as the Internet. The search engine may also include one or more advertisements in the search result page with the links to the relevant containers. The advertisements may be randomly chosen, may be selected based on their relevance to the search query, or may be based on some other criteria.

In step 450, the search engine provider receives revenue associated with the display of the advertisements to the user. In one embodiment, if the advertiser pays the search engine on a pay-per-impression basis, the search engine receives revenue each time the advertisement is included in a web page that is displayed to a user. In another embodiment, if the advertiser pays the search engine on a pay-per-click basis, the search engine receives revenue each time a user clicks on the advertisement that is displayed in a web page provided to the user by the search engine. It should be noted that the invention is not limited to these two examples of revenue generation. One skilled in the art will recognize that there other revenue generation methods that a search engine may use to generate revenue associated with the display of a search result. All such methods are within the scope of the present invention.

In step 460, the search engine allocates a portion of the revenue to an owner of a container included in the search result with the advertisement. As discussed previously, users may register with the search engine when creating and/or submitting containers. As a result, the search engine may know the authors of one or more of the containers. The author is considered the owner of the container and will receive the revenue unless the author has transferred his rights to a third party. In this case, the third party will receive the revenue as owner of the container.

In one embodiment, the search engine allocates a portion of the revenue to the owners of the containers that make up a search result. For example, a search result may be comprised of twenty relevant containers. In one embodiment, only a set of the five containers may be displayed to the user at a given time along with the advertisement. The search engine may allocate revenue generated from the display of the advertisement to all twenty of the containers that make up the search result.

In an alternative embodiment, the search engine may allocate a portion of the revenue to the owners of the containers that are actually displayed in the search result with the advertisement. For example, if the search result comprises twenty containers, which are displayed to the user in sets of five containers per page, only five containers will be displayed with the advertisement. In this example, the search engine may allocate a portion of the revenue generated from the display of the advertisement to the owners of the five containers listed in the search result with the advertisement. In this embodiment, the other fifteen container owners do not receive a portion of the revenue. This embodiment encourages container owners to continuously update and improve their containers so that their containers receive good feedback from users which improves their ranking within the search result.

In one embodiment, the search engine provider may retain a portion of the received revenue not allocated to the owners of the containers. For example, if the search result includes three containers, the search engine provider may retain a percentage of the generated revenue (e.g. 50%) and allocate the remainder of the generated revenue equally between the owners of the three containers. One skilled in the art will recognize that there are a number of ways to allocate a portion of the revenue with the owners of the containers, all of which are within the scope of the present invention.

In one embodiment, the search engine provider may penalize authors who have multiple containers within a given search result. For example, if a search result includes six containers and two of the containers have the same owner, the search engine may reduce the share of the revenue allocated to the owner of the multiple containers. In one embodiment, the share of the revenue for the owner of multiple containers within a search result is divided by the number of containers within the search result owned by a common owner. Thus, if the owner has two containers in the search, the owner's share is reduced by half. This provides an incentive to authors/owners to limit the scope of a container to a specific topic. It also provides a disincentive to creating/owning multiple containers that cover the same topic.

In one embodiment, revenue generated from one or more advertisements, affiliate program links, or other services included within a container may also be shared between the search engine and the owner of the container. For example, when a user selects (e.g. clicks) a link within the search results page associated with a container, the container is displayed to the user. As discussed above, the container may include text or other information about the topic described in the header of the container and/or links to one or more web pages that have additional information about the topic of the container. The container may also comprise advertisements, affiliate program links and/or other revenue generating services included within the body of the container by either the search engine or the author of the container. In this case, the search engine provider may allocate revenue generated from the display of the container between itself and the owner of the container.

In one embodiment, affiliate program links are a form of marketing that businesses use to attract customers. Either a container owner or the search engine may include a link within the container or on the same page as the container to an affiliate web site or business. For each customer that the container introduces to the affiliate web site or business, the affiliate program link will generate revenue that may be allocated between the container and the provider of the search engine. For example, affiliate programs may pay revenue on a pay-per-click basis as discussed previously with respect to advertisements or may pay a commission based on sales made by a customer that originated from the affiliate program link clicked within the container. One skilled in the art will recognize that there are a number of ways to generate money from the display of a container. All of such methods are considered within the scope of the present invention.

In one embodiment, the revenue generated from the advertisement and/or affiliate program or other revenue generating service within the container is allocated between the search engine and the owner of the container. For example, the service provider may allocate 80% of the revenue to the owner of the container and retain the remaining 20%. One skilled in the art will recognize that there are a number of ways to allocate the revenue between the search engine and the owner of the container, all of which are considered within the scope of the present invention. In an alternative embodiment, all of the revenue associated with the display of the container or advertisements within the container may be allocated to the owner of the container. These embodiments provide an incentive to authors to create and maintain containers.

Aspects of the present invention may be implemented in any device or system or combination of devices or systems capable of performing according to the teachings of the present invention. Such devices and/or systems include, but are not limited to, a computer or a device with one or more processors. Furthermore, within any of the systems or devices, aspects of the present invention may be implemented in a wide variety of ways including software, hardware, firmware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application-specific integrated circuits (ASICs), programmable logic devices (PLDs), flash memory devices, and ROM and RAM devices. Examples of computer code include machine code, such as produced by a compiler, and files containing higher level code that are executed by a computer using an interpreter.

While the present invention has been described with reference to certain embodiments, those skilled in the art will recognize that the invention is not limited to the specific embodiments discussed. For example, although the invention was described with respect allocating revenue generated by a search engine from advertisements and/or affiliate program links, one skilled in the art will recognize that any source of revenue generated by the search engine may be shared with the users who author content for the search engine. Variations upon and modifications to the embodiments are provided for by the present invention.

What is claimed is:

1. A method for allocating revenue received by a search engine, comprising:
receiving a search query from a user;
identifying at least one container relevant to the search query;
generating a search result comprising a link to the at least one container;
transmitting the search result and an advertisement for display to the user; and
allocating a portion of revenue associated with the display of the advertisement to an owner of the at least one container included in the search result with the advertisement.

2. The method of claim 1 wherein the container includes content input by or linked to by an author through an interface provided by the search engine.

3. The method of claim 1 wherein the search result comprises links to a plurality of containers and the plurality of containers are ordered within the search result according to a ranking.

4. The method of claim 3 wherein the user provides ranking information for a container based on a relevance of the container to the search query.

5. The method of claim 1 wherein revenue is generated in response to the display of the advertisement to the user.

6. The method of claim 1 wherein revenue is generated in response to the user clicking on the advertisement.

7. The method of claim 1 wherein a provider of the search engine retains a second portion of the received revenue.

8. The method of claim 1 wherein a link is a pointer to the container that causes the container to be displayed to the user in response to the user selecting the link.

9. The method of claim 8 wherein revenue generated from the display of an advertisement with the container is allocated between a provider of the search engine and the owner of the container.

10. The method of claim 9 wherein revenue is generated in response to a user clicking on the advertisement.

11. The method of claim 1 wherein the revenue allocated to the owner of a container is reduced if the search result comprises a plurality of containers owned by the owner.

12. A search engine, comprising:
a query module for receiving a search query over a network, identifying one or more containers relevant to the search query, and creating a search result comprising a link to at least one of the containers relevant to the search query and an advertisement; and
a revenue module for allocating a portion of revenue generated from display of the advertisement with an owner of the at least one containers relevant to the search query.

13. The search engine of claim 12 further comprising an indexer module that receives a container and creates an index of the container to facilitate searching of the container.

14. The search engine of claim 13 wherein the indexer module receives the container through an interface provided by the search engine and stores the container in a storage medium.

15. The search engine of claim 12 further comprising a ranking module for computing a ranking for each of the containers stored in the storage medium, wherein the links are ordered in the search result according to the ranking.

16. A computer program product embodied on one or more computer readable media for allocating revenue received by a search engine, the computer program product comprising computer instructions for:
receiving a search query from a user;
identifying at least one container relevant to the search query;
generating a search result comprising a link to the at least one container;
transmitting the search result and an advertisement for display to the user; and
allocating a portion of revenue associated with the display of the advertisement to an owner of the at least one container included in the search result with the advertisement.
